(19) United States
(12) Patent Application Publication
(10) Pub. No.: US 2008/0209254 A1
(43) Pub. Date: Aug. 28, 2008

(54) METHOD AND SYSTEM FOR ERROR RECOVERY OF A HARDWARE DEVICE

(76) Inventors: Brian Robert Bailey, San Jose, CA (US); Carl David Kambites, Southhampton (GB); Gary Michael Sanderson, Tucson, AZ (US); Ronald J. Venturi, (US)

Correspondence Address: INTERNATIONAL BUSINESS MACHINES CORPORATION, 650 Harry Road, L2PA/J2C, INTELLECTUAL PROPERTY LAW, SAN JOSE, CA, 95120-6099, US

(21) Appl. No.: 11/677,921

(22) Filed: Feb. 22, 2007

(51) Int. Cl. G06F 11/00

(52) U.S. Cl. 714/2

(57) ABSTRACT

A method and system for error recovery of a hardware device is provided. The method includes detecting a target hard error indication from the hardware device by comparing the hard error indication to signatures of hard error indications which indicate a temporary failing and modifying the reported error to a stalling indication. The hardware device is allowed to recover in a predefined time period or by issuing one or more resets, or both. A hard error indication usually instigates an external error recovery of the hardware device and the method temporarily stalls such external error recovery.

### BACKGROUND OF THE INVENTION

1. Field of the Invention

This invention relates to the field error recovery of a hardware device, and more particularly, to surviving hard error conditions of a hardware device.

2. Background Information

Computing systems contain many hardware devices, any of which may suffer a hardware failure at any time. Computing systems include Reliability, Availability, Serviceability (RAS) functions which can analyze the behavior of its hardware devices to determine if and when a device needs to be replaced. If a device indicates a “hard error” condition, it has already exhausted its internal error-recovery steps, and is reporting that it cannot complete an operation. The RAS functions are designed to detect these “hard error” indications and invoke a service action to replace the failing device.

Hardware devices may take the form of printers, storage devices, including tape drives and disk drives, and scanners, for example. These hardware devices may use an architected interface which supports command status and result values, for example a Small Computer System Interface (SCSI) interface.

In the case of storage sub-systems, a failing hardware device, such as a storage device, is of special significance since it may contain a vast amount of user data. Replacement of a storage device will include action to preserve the data, whether by recovering it from the failing device before replacement, or by rebuilding it from other sources. The time and effort required to preserve user data, and the cost of the device itself, make storage device replacement a costly service action.

Modern hard disk drives are complex devices, and in some circumstances a drive may exhibit a “hard error” characteristic for a very short period of time (seconds) but then recover to normal operation. However, the sub-system RAS function will already have detected the error indication and started the replacement process, and even though the drive may have recovered from the temporary failure condition, its replacement cannot be avoided.

Known solutions to the problem of avoiding drive replacement after a “hard error” report are primarily based on retrying the failing operation to see if the error repeats. However, this is an arbitrary action, with no consideration of the time lapse between initial command and retry. In most circumstances, the retry will occur only a few milliseconds after the initial command, and so this method does not address failure conditions which are temporary but which persist for several seconds. Furthermore, this method does not include any action to address the cause of the “hard error” condition in the device, on the assumption that the device has already exhausted all possible recovery steps.

It is an aim of the invention to allow temporary “hard error” conditions in a device to be tolerated by the system, allowing the device to remain in use and avoiding the costly replacement process and consequent inconvenience to the user.

### SUMMARY OF THE INVENTION

According to a first aspect of the invention, a method for error recovery of a hardware device is provided. In the method, a managing component of a hardware device comprises detecting a target hard error indication from the hardware device, modifying the reported hard error indication to a stalling indication, and allowing the hardware device to recover. Detecting a target hard error indication may compare the hard error indication to signatures of hard error indications which indicate a temporary failing. A hard error indication usually instigates an external error recovery of the device, and the method may temporarily stall such external error recovery.

Allowing the hardware device to recover may include setting a time period in which the error condition can terminate. The time period may be set as an estimate of the duration of a likely error condition. Alternatively or additionally, allowing the hardware device to recover may include resetting the hardware device.

In one embodiment, the method includes setting a first time period commencing at a first instance of a target hard error indication, in which first time period the hardware device is allowed to recover. Then setting a second time period commencing after the expiry of the first time period, in which second time period further target hard error indications are monitored. Further target hard error indications may be detected during the second time period resulting in a rejection of the hardware device.

The hardware device may be any one of a storage device, a printer, a scanner, or other peripheral device. The method may be carried out in a storage device manager, a printer manager, a scanner manager, and other hardware devices. The hard error indication and the stalling indication may be provided on an architected interface, for example, a SCSI interface.

According to a second aspect of the invention, there is provided a system for error recovery of a hardware device. The system includes a managing component of the hardware device. The managing component includes a device for detecting a target hard error indication from the hardware device. Further included in the managing component is a device for modifying the reported hard error indication to a stalling indication; and device for allowing the hardware device to recover.

According to a third aspect of the invented method may be provided on a computer program product stored on a computer readable storage medium. Such a storage medium may comprise a computer readable program code that performs the method of the invention.

### BRIEF DESCRIPTION OF THE DRAWINGS

FIG. 1 is a block diagram of a system in which the invention may be implemented;

FIG. 2 is a block diagram of a storage sub-system in which the invention may be implemented;

FIG. 3 is a block diagram of a system in accordance with the invention;

FIG. 4A and FIG. 4B are schematic flow diagrams of a method in accordance with the invention;

FIG. 5 is schematic diagram of a error recovery procedure timeline in accordance with an aspect of the invention; and

FIG. 6 is a block diagram of a computer system in which the invention may be implemented.

### DESCRIPTION OF THE PREFERRED EMBODIMENTS

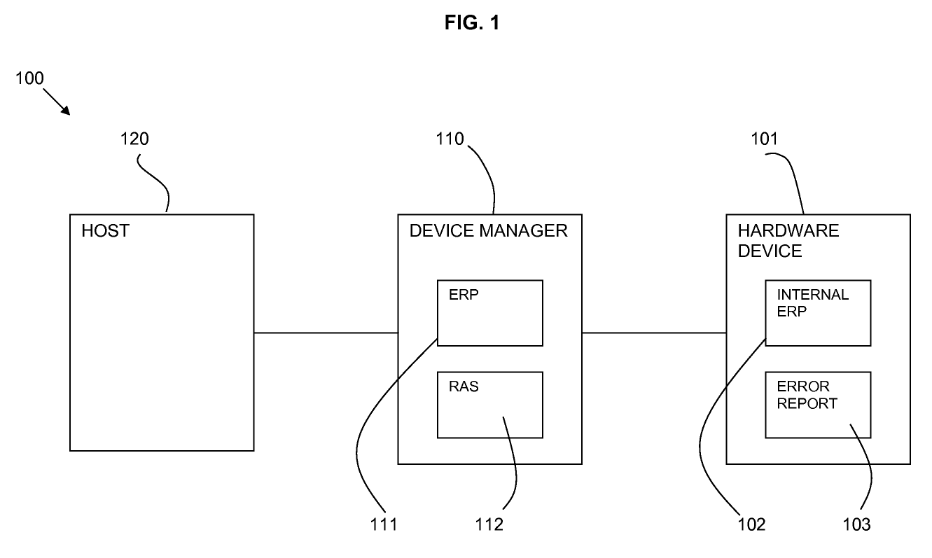

Referring to FIG. 1, a schematic of a computer system 100 is shown in which a hardware device 101 is provided. A host 120 of the computer system 100 may use the hardware device 101 for its intended purpose. For example, the hardware device 101 may be a printer, a scanner, a storage device including, a tape drive or a disk drive, or any other peripheral hardware device.

The hardware device 101 includes an internal error recovery system 102 and an error reporting device 103. The hardware device 101, alone or with multiple other hardware devices, is managed by a device manager 110. The hardware device 101 uses an architected interface which supports command status from the device manager 110 and result values. The architected interface may be a SCSI interface.

The device manager 110 includes an error recovery procedure (ERP) 111 which receives the reported errors from the hardware device, or devices, 101. The device manager 110 also includes Reliability, Availability, Serviceability (RAS) functionality 112 which analyses the reported errors of the hardware device(s) 101 and invokes service actions on the hardware device 101.

The method and system for error recovery of a hardware device includes the device manager 110 detecting a type of hard error indication from the hardware device, that indicates a temporary device failing. The device manager 110 modifies the reported hard error indication to a stalling indication, allowing the hardware device to recover.

The method and system can identify and manage a failure signature which may only become evident after widespread use of the hardware device. In such instances, the failure mechanism was not known during development or system integration of the device. If it had been known, then there would have been an opportunity to present a stalling indication directly from the device, as architected interfaces are designed to do.

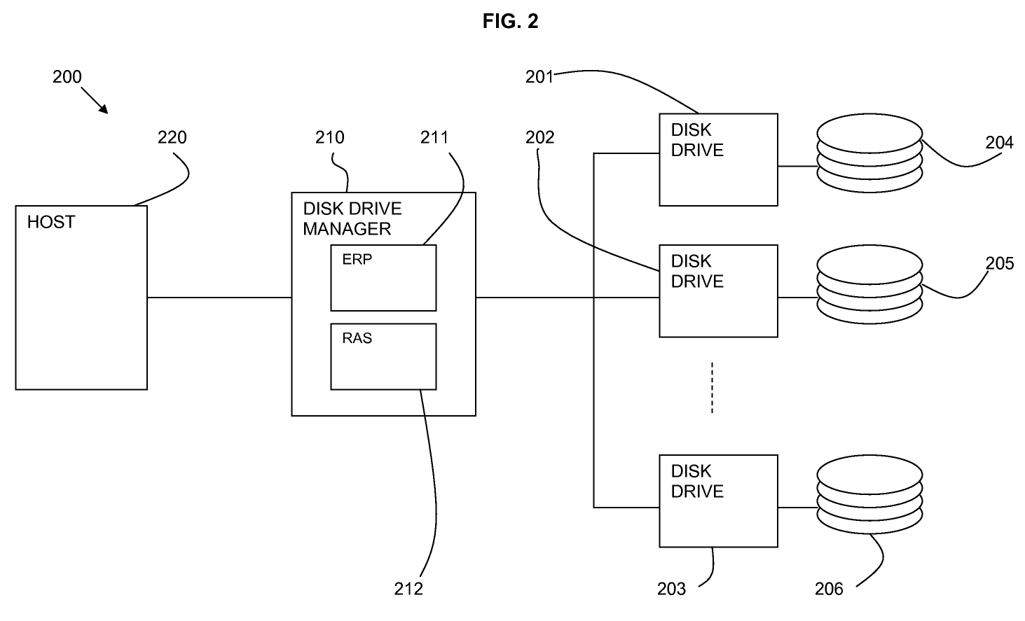

In an embodiment, a hardware device is a storage device, for example, a hard disk drive. FIG. 2 shows a block diagram of a storage sub-system 200 which may be used by a host 220 directly or via a network. The storage sub-system 200 has at least one disk drive manager 210 which includes an ERP 211 and RAS functionality 212. The disk drive manager 210 manages a plurality of disk drive modules (DDMs) 201-203. Each of the disk drive modules 201-203 has a plurality of storage disks 204-206.

An implementation of an embodiment of the invention is described in a disk drive manager in the form of a SCSI device adapter as an initiator and a SCSI drive as the target device. When a SCSI target device returns a check condition in response to a command, the initiator usually issues a SCSI “Request Sense” command. The target responds to the “Request Sense” command with a set of SCSI sense data in the form a Key Code Qualifier (KCQ). The KCQ includes three fields giving increasing levels of detail about the error:
K—sense key—4 bits
C—additional sense code (ASC)—8 bits
Q—additional sense code qualifier (ASCQ)—8 bits

The K field indicates the severity of the error and includes categories of: No Sense, Soft Error, Not Ready, Medium Error, Hard Error, Illegal Request, Unit Attention, Write Protected, Aborted Command, and Other. The KCQ system of condition indicators is an example of a condition reporting system. Other systems may be used which include a hard error condition for a device that indicates that the device has exhausted its internal error recovery procedures. A hard error condition usually indicates that an external device manager may instigate the device removal. A stalling condition should also be available which can be used to replace the hard error condition to allow time for the device to recover. In the case of the KCQ system, the hard error condition is “Hard Error” and the stalling condition is “Not Ready”.

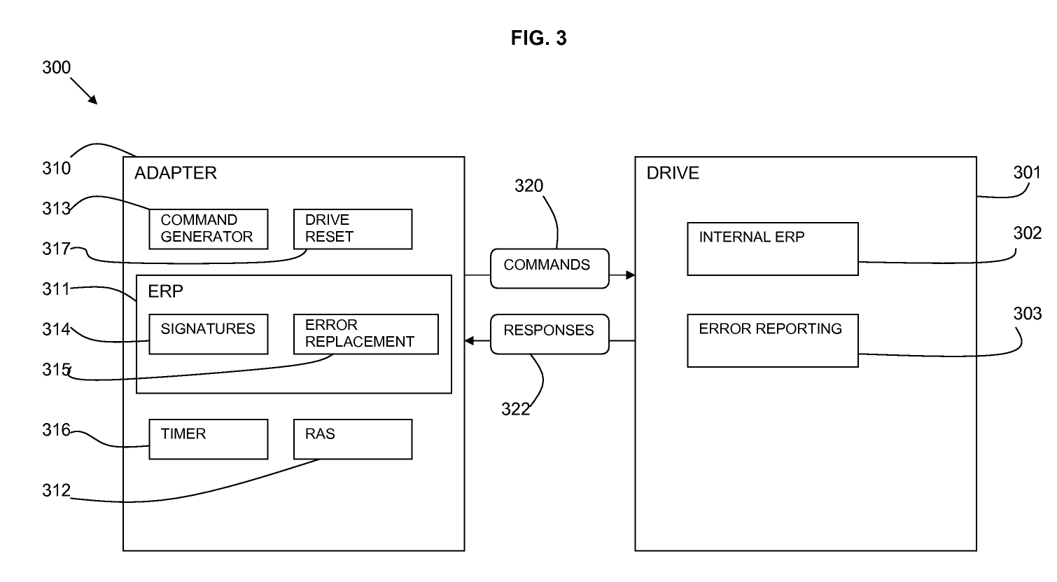

FIG. 3 shows a block diagram of a storage sub-system 300 for implementation with a SCSI adapter 310 and a SCSI drive 301. The adapter 310 issues commands 320 to the drive 301 and the drive returns responses 322 to the adapter 310.

The adapter 310 includes a command generator 313 and an ERP 311. The ERP 311 includes signatures 314 of known temporary error conditions and an error indication replacement device 315. The adapter 310 also includes a timer 316, a drive reset device 317, and RAS functionality 312. The drive 301 includes an internal error recovery device 302 and an error reporting device 303.

In the proposed method “Hard Error” indications are detected by the adapter 310. The KCQs of the “Hard Error” indications are compared to signatures 314 of temporary error conditions within the drive 301. When these KCQs of the “Hard Error” match the signature 314 of a known temporary error condition within the drive 301, the adapter 310 error replacement device 315 replaces the “Hard Error” KCQ with a different KCQ which indicates a stalling of the device, for example, a “Not Ready” indication. The “Not Ready” indication causes the sub-system to re-submit the command.

Meanwhile, the adapter 310 has started a timer 316 which matches the likely period of the temporary error condition in the drive 301. If the re-submitted command continues to fail, the adapter will continue to report device “Not Ready”, until the allowable period of the temporary error is exhausted.

Some temporary hard error indications cause the drive 301 to latch that condition, such that it cannot be cleared by simply re-submitting the command, but instead requires a SCSI reset 317. Since in this case the method is implemented outside the device 301 itself, it includes device recovery actions as part of the solution. In one embodiment, while the adapter 310 is reporting device “Not Ready” to the sub-system, the adapter 310 is also attempting to clear the error condition in the drive 301 by issuing SCSI “Reset” to the drive 301. In this way, the method is preventing the sub-system RAS function 312 from starting a drive replacement action, while actively resetting the drive 301 to clear the temporary failure condition.

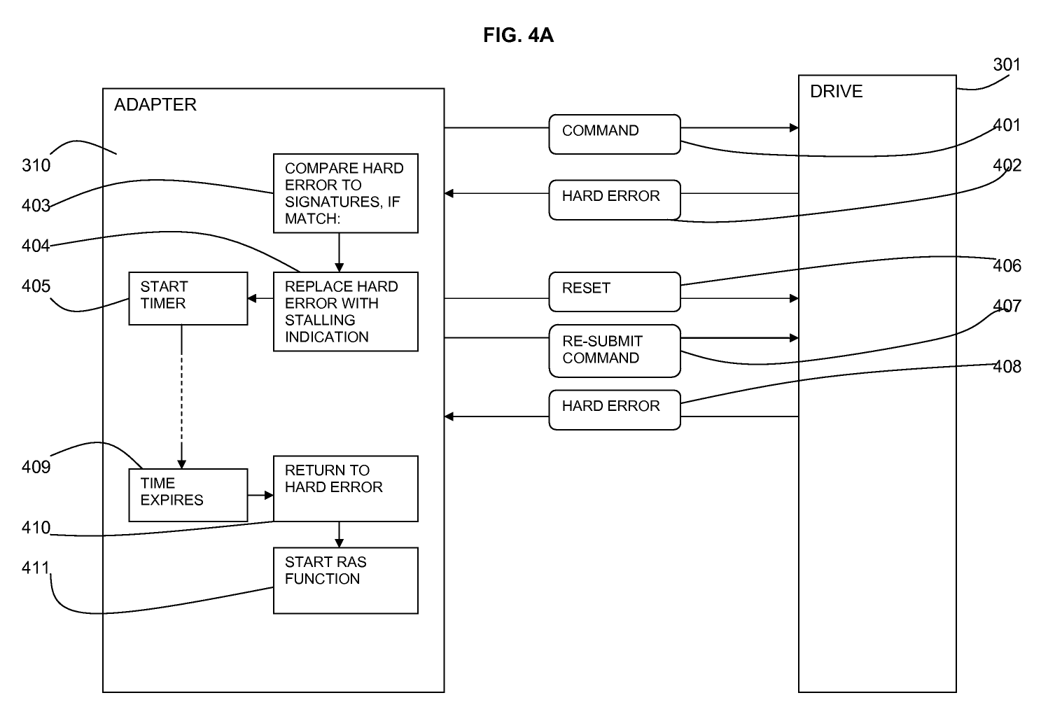

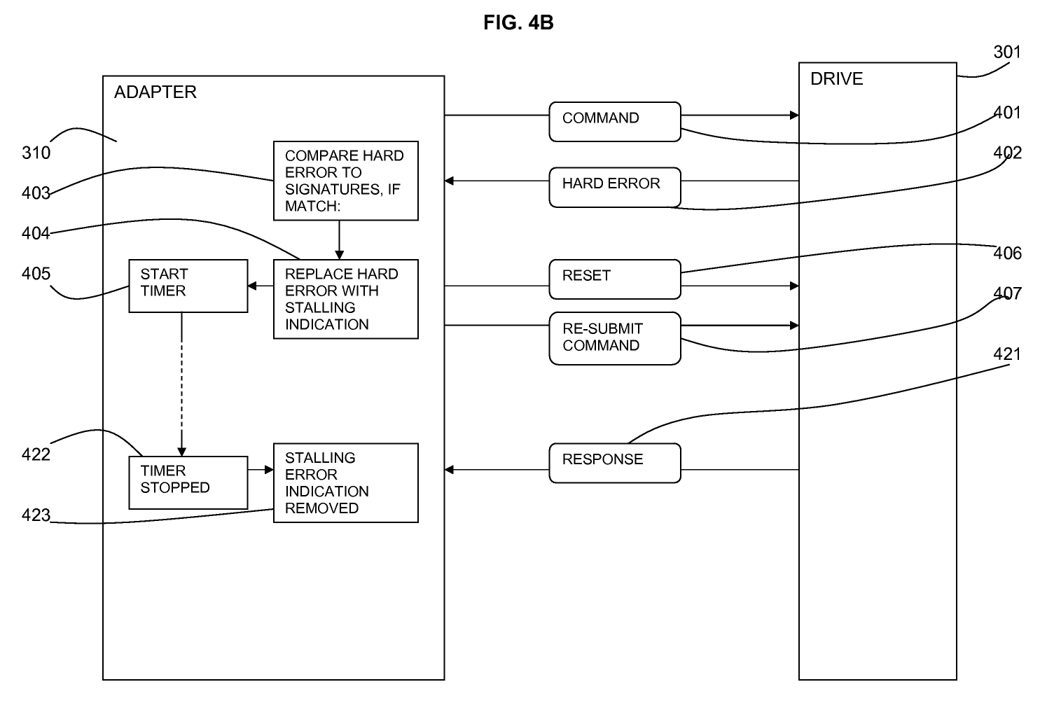

FIGS. 4A and 4B are schematic flow diagrams of the commands and responses between an adapter 310 and a drive 301. In FIG. 4A, the error is unable to be overcome after a pre-determined time. In FIG. 4B, the error is overcome and the drive 301 avoids drive replacement action. In both FIGS. 4A and 4B, the adapter 310 issues a command 401 to the drive 301 who responds with a “Hard Error” response 402. The adapter 310 compares 403 the hard error to signatures of temporary errors and, if there is a match, the “Hard Error” is replaced 404 with a stalling indication such as a “Not Ready” indication. At the same time as the “Hard Error” is replaced 404 with a “Not Ready” indication, the adapter starts a timer 405. A reset command 406 is sent to the drive 301 to attempt to address the cause of the error. The original command is also resent 407 by the adapter 310.

In the scenario shown in FIG. 4A, the resent command 407 continues to return 408 a “Hard Error”. The timer expires 409 with the error continuing to be shown. The adapter 310 returns the error indication to “Hard Error” 410 and the RAS functionality is instigated 411.

In the scenario shown in FIG. 4B, the resent command 407 is actioned and returns an appropriate response 421. The timer expires with no consequence or is stopped 422 when the appropriate response 421 is received by the adapter 310. The stalling indication is removed 423 and the drive 301 continues to operate having avoided drive replacement action.

The overall objective is to allow the drive to survive an extended period of hard errors (for example, vibration-induced errors) by stalling the I/O stream to the drive, while also providing up to two SCSI resets to the drive in an attempt to clear the condition.

In an example in which the hard errors are caused by a vibration of the drive, the adapter error recovery procedure (ERP) detects target KCQs which indicate the occurrence of a vibration event in the drive and therefore suggest a temporary problem. The ERP also determines the optimum points to apply resets and modifies the reported KCQ to avoid immediate rejection of the drive by the adapter. The ERP also issues the device resets to attempt to clear the error state in the drive

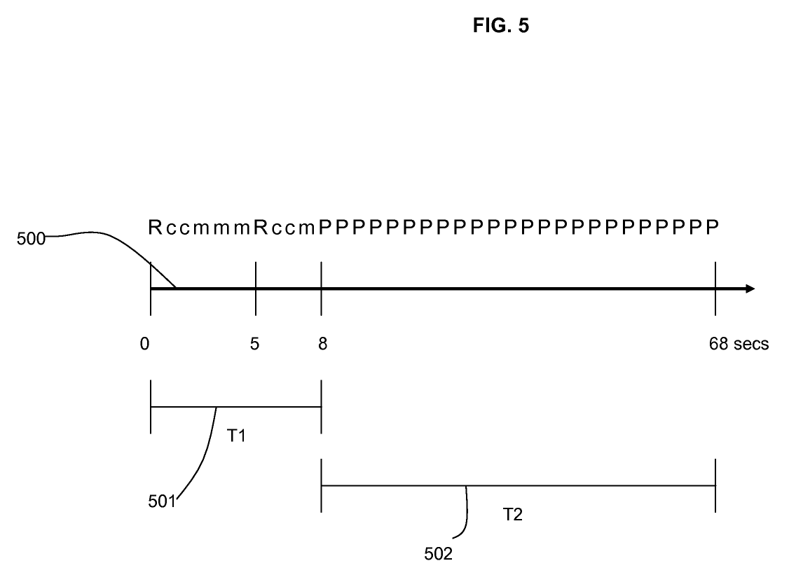

In an example embodiment, a timer measures two pre-defined event values. FIG. 5 shows the timeline 500 for this embodiment. It illustrates how the method is tuned to the specific needs of the failure condition. A first time period T1 501 is set at 08 seconds—this represents the maximum “tolerable” duration of the error event.

A second time period T2 502 is set at 60 seconds—this represents the period immediately after an error event, during which a subsequent error event cannot be tolerated.

The following is a key to the annotations on the timeline 500:
R=Reset the drive on error event.
m=modify the KCQ on error event.
c=configuration only, no read/write, so no chance of error event.
P=pass the KCQ unmodified on error event.

The first occurrence of any of the target KCQs invokes the ERP:
T1 starts counting down.
Adapter recognizes the error signature, and issues Device Reset.
Adapter indicates “not ready” to the Command Generator (CG).
CG sends re-configuration commands to the DDM, then resubmits I/O.
Any subsequent target KCQs during T1 causes the Adapter to indicate “not ready” to the CG, which continues to re-submit commands.
DDM is stalled.

When T1 reaches 3 seconds left i.e. 5 seconds since start of error event:
Next target KCQ will cause a second Device Reset.
Adapter indicates “not ready” to the Command Generator (CG).
CG sends re-configuration commands to the DDM, then resubmits I/O.
Any subsequent target KCQs during T1 cause the Adapter to indicate “not ready” to the CG, which continues to re-submit commands.
DDM remains stalled.

When T1 expires,
T2 starts counting down (counting “can't tolerate another error” time interval).
If any target KCQ arrives during T2 period, it passes unmodified to the adapter.
The adapter ERP will immediately reject the drive.
DDM is rejected—timers are stopped.

If T2 expires (i.e. no repeat of the error event),
Event is over—Timers are disabled.
DDM remains in operation, and ready for next event.

The overall effect of the embodiment is that the adapter has detected a unique failure condition, applied up to two Device Resets 5 seconds apart, and prevented the system from immediately rejecting the device. If the error does not repeat within 60 seconds, the device has recovered from the temporary error condition, and continues in use. Otherwise the device is now properly rejected for repeated failures.

In another embodiment, the hardware device is a printer device with a printer manager. The printer device may develop an unexpected mechanical wear-out condition after a period of continuous operation. It may then be found that applying the SCSI reset several times with a given time interval between resets, will normally recalibrate the device sufficiently to clear the error condition for a further period of time.

Therefore, if the printer reports a hard error indication that represents the mechanical wear-out condition, the printer manager substitutes the hard error indication with a stalling error indication whilst the resets are carried out. This is a much better solution than having to replace the printer.

The assumption is that it is not possible to re-program a commodity device (the printer, disk drive, etc.) but it is possible to add an extra step in the error recovery process to apply the proposed stalling ERP.

The above example implementations are examples of many that may be applied in error recovering procedures for storage devices or other hardware devices with error reporting. The time periods may be varied according to likely time periods in which the hardware device may overcome problems. Different numbers of reset attempts may be made according to the device.

If the temporary failing condition is well understood, and it produces a consistent error pattern from the device, there is an opportunity to detect that failing condition within the computing system, and attempt to survive the short period of failure by replacing the “hard error” indication with a “not ready” indication. When these indications have a standard meaning across the computing system, modifying them allows different system actions to be invoked, without the need for widespread system functional changes.

Further, this “stalling” process can be tuned to the specific parameters of the error condition and the operating environment. For example, a threshold time may be established under which the temporary errors will continue to be tolerated by the system.

The proposed method and system do not require any changes to the target device as it operates in a higher-level process outside the device, for example, in the disk drive adapter for a storage device. The target device continues in use with no changes to it.

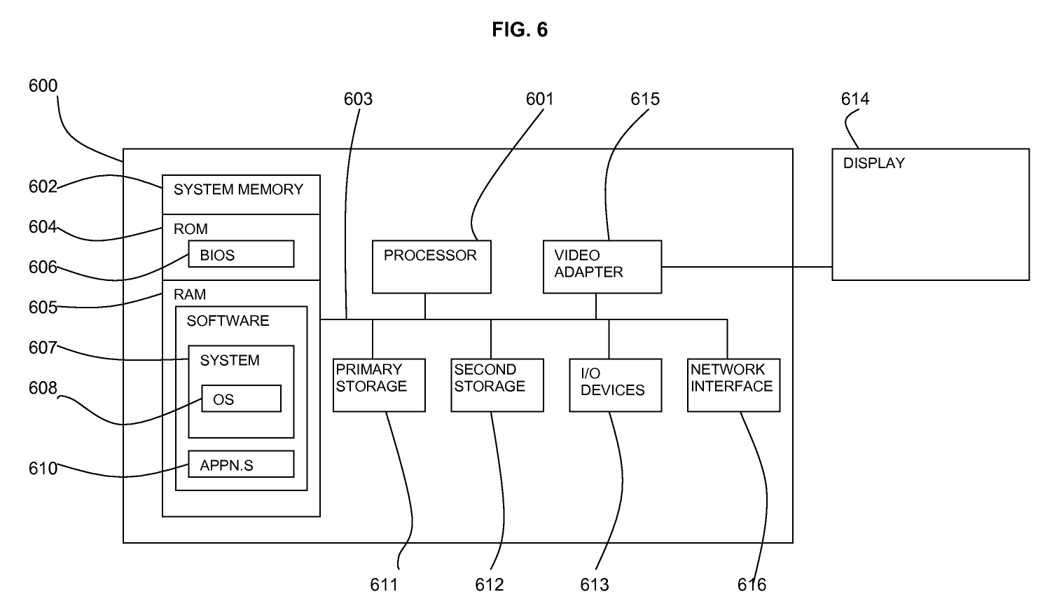

Referring to FIG. 6, there is shown an exemplary system for implementing the described method as a computer program product. The system includes a data processing system 600 suitable for storing and/or executing program code including at least one processor 601 coupled directly or indirectly to memory elements through a bus system 603. The memory elements can include local memory employed during actual execution of the program code, bulk storage, and cache memories which provide temporary storage of at least some program code in order to reduce the number of times code must be retrieved from bulk storage during execution.

The memory elements may include system memory 602 in the form of read only memory (ROM) 604 and random access memory (RAM) 605. A basic input/output system (BIOS) 606 may be stored in ROM 604. System software 607 may be stored in RAM 605 including operating system software 608. Software applications 610 may also be stored in RAM 605.

The system 600 may also include a primary storage device 611, such as a magnetic hard disk drive, and secondary storage device 612 such as a magnetic disc drive and an optical disc drive. The drives and their associated computer-readable media provide non-volatile storage of computer-executable instructions, data structures, program modules and other data for the system 600. Software applications may be stored on the primary and secondary storage device 611, 612 as well as the system memory 602.

The computing system 600 may operate in a networked environment using logical connections to one or more remote computers via a network adapter 616. Input/output devices 613 can be coupled to the system either directly or through intervening I/O controllers. A user may enter commands and information into the system 600 through input devices such as a keyboard, pointing device, or other input devices (for example, microphone, joy stick, game pad, satellite dish, scanner, or the like). Output devices may include speakers, printers, etc. A display device 614 is also connected to system bus 603 via an interface, such as video adapter 615.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for error recovery of a hardware device comprising:
detecting a target hard error indication from the hardware device;
modifying the reported hard error indication to a stalling indication; and
allowing the hardware device to recover.

2. The method of claim 1 wherein detecting a target hard error indication compares the hard error indication to signatures of hard error indications which indicate a temporary failing.

3. The method of claim 1 wherein a hard error indication instigates an external error recovery of the hardware device and wherein the method temporarily stalls such external error recovery.

4. The method of claim 1 wherein allowing the hardware device to recover includes setting a time period in which the error condition can terminate.

5. The method of claim 4 wherein the time period is set as an estimate of the duration of a likely error condition.

6. The method of claim 1 wherein allowing the hardware device to recover includes resetting the hardware device.

7. The method of claim 1 further comprising:
setting a first time period commencing at a first instance of a target hard error indication, the hardware device allowed to recover during the first time period; and
setting a second time period commencing after the expiry of the first time period, further target hard error indications monitored during the second time period.

8. The method of claim 7 wherein further target hard error indications detected during the second time period result in a rejection of the hardware device.

9. The method of claim 1 wherein the hardware device is a selected one of a storage device, a printer, and a scanner; and
wherein the method is carried out in a selected one of a storage device manager, a printer manager, and a scanner manager.

10. The method of claim 1 wherein the hard error indication and the stalling indication are provided on an architected interface.

11. A system for error recovery of a hardware device comprising:
a device manager for managing error recovery of the hardware device, the device manager detecting a target hard error indication from the hardware device, upon receiving a target hard error indication, the device manager modifying the reported hard error indication to a stalling indication for allowing the hardware device to recover.

12. The system of claim 11 wherein the target hard error indication includes signatures of hard error indications which indicate a temporary failing against which the hard error indication is compared.

13. The system of claim 11 wherein the device manager includes a timer with a pre-defined time period in which the error condition can terminate.

14. The system of claim 13 wherein the time period is set as an estimate of the duration of an error condition.

15. The system of claim 11 wherein the device manager includes a device for resetting the hardware device.

16. The system of claim 11 further comprising:
a first timer for a first time period commencing at a first instance of a target hard error indication, the hardware device allowed to recover in the first time period; and
a second timer for a second time period commencing after the expiry of the first time period, further target hard error indications monitored during the second time period.

17. The system of claim 11 wherein the hardware device is a selected one of a storage device, a printer, and a scanner; and
wherein the device manager is a selected one of a storage device manager, a printer manager, and a scanner manager

18. The system of claim 11 wherein the hardware device is coupled to the managing component by an architected interface.

19. A computer program product stored on a computer readable storage medium, comprising computer readable program code for performing the steps of:
detecting a target hard error indication from the hardware device;
modifying the reported hard error indication to a stalling indication; and
allowing the hardware device to recover.
